(19) United States
(12) Patent Application Publication
(10) Pub. No.: US 2026/0321241 A1
(43) Pub. Date: Oct. 15, 2026

(54) INFORMATION PROCESSING APPARATUS, INFORMATION PROCESSING METHOD, PROGRAM, AND INFORMATION PROCESSING SYSTEM

(71) Applicant: SONY GROUP CORPORATION, TOKYO (JP)

(72) Inventor: KAZUYOSHI HORIE, TOKYO (JP)

(21) Appl. No.: 19/485,292

(22) PCT Filed: May 22, 2024
(86) PCT No.: PCT/JP2024/018855

§ 371 Date: Nov. 18, 2025

(30) Foreign Application Priority Data
Jun. 1, 2023 (JP) 2023-090677

(51) Int. Cl. G10L 13/033; G10L 13/047; G10L 13/08

(52) U.S. Cl. CPC G10L 13/033; G10L 13/047; G10L 13/08

(57) ABSTRACT

An information processing apparatus includes: a speaker search unit that performs a search based on a topic of text data among a plurality of pieces of speaker data to select speaker data; and a voice synthesis unit that generates synthesized voice data of the text data with the speaker data selected by the speaker search unit.

### TECHNICAL FIELD

The present technology relates to an information processing apparatus, an information processing method, a program, and an information processing system, and relates to, for example, voice synthesis processing used for a narration, a speech, or the like of content.

### BACKGROUND ART

In recent years, content using voice synthesis (text to speech (TTS)) for a narration is increasing in distribution services. A plurality of TTS speakers is provided for voice synthesis software and voice synthesis services to be used, and a user can select a voice quality suitable for the user's content.

Patent Document 1 below discloses a technology for selecting a male voice or a female voice by aggregating appearance rates in a male sentence and a female sentence for respective words used in a sentence to be read.

### CITATION LIST

### Patent Document

Patent Document 1: Japanese Patent Application Laid-Open No. H11-296193

### SUMMARY OF THE INVENTION

### Problems to be Solved by the Invention

In a case where the number of TTS speakers to be provided is small, the user can select a voice suitable for the user's content by listening to sample voices and the like of all the TTS speakers on a trial basis, but conversely, there are few choices. On the other hand, when the number of TTS speakers to be provided is increased, it takes time for the user to listen to the sample voices of all the speakers on a trial basis. Furthermore, in a case where there is a voice quality of a similar image, it is conceivable that it is difficult to determine which voice is suitable for the user's content.

In order to make it easy for the user to select a voice, there are a method of distinguishing voices in stages according to the level of the frequency of the voice of the TTS speaker, a method of distinguishing voices by the sex or age of the TTS speaker, a method of distinguishing voices by the voice image of the TTS speaker (for example, “adult voice”, “energetic voice”, or the like), and the like.

However, for example, even if a speaker is selected as “a man with a medium-level voice frequency”, it is considered that a desired voice quality varies depending on whether the content is a documentary program or a sports program.

In the technology of Patent Document 1, text to be read is limited to “spoken words”. For that reason, it is still insufficient for suggesting a voice according to content detail.

Thus, the present technology makes it possible to more accurately provide a user with a voice suitable for content detail among selectable voices.

### Solutions to Problems

An information processing apparatus according to the present technology includes: a speaker search unit that performs a search based on a topic of text data among a plurality of pieces of speaker data to select speaker data; and a voice synthesis unit that generates synthesized voice data of the text data with the speaker data selected by the speaker search unit.

Speaker data with a voice quality according to a topic (subject or genre thereof) as detail of text data is selected, and a read voice of the text data is synthesized, with the speaker data.

### BRIEF DESCRIPTION OF DRAWINGS

FIG. 1 is an explanatory diagram of a system configuration according to an embodiment of the present technology.

FIG. 2 is an explanatory diagram of a functional configuration of an information terminal according to the embodiment.

FIG. 3 is an explanatory diagram of a functional configuration of a voice synthesis server according to the embodiment.

FIG. 4 is an explanatory diagram of a functional configuration of a content analysis server according to the embodiment.

FIG. 5 is an explanatory diagram of a functional configuration of a database according to the embodiment.

FIG. 6 is an explanatory diagram of processing by the TTS speaker suggestion system according to the embodiment.

FIG. 7 is an explanatory diagram of examples of topics used in the embodiment.

FIG. 8 is an explanatory diagram of a learning process of a feature amount of voice according to the embodiment.

FIG. 9 is a flowchart of topic model generation processing according to the embodiment.

FIG. 10 is a flowchart of TTS reference data generation processing according to the embodiment.

FIG. 11 is a flowchart of processing by the speech synthesis server according to the embodiment.

FIG. 12 is a flowchart of processing by a database according to the embodiment.

FIG. 13 is an explanatory diagram of a display example by the information terminal according to the embodiment.

FIG. 14 is a flowchart of time stamp setting according to a voice feature amount change according to the embodiment.

FIG. 15 is a flowchart of TTS reference data generation processing referring to a time stamp according to the embodiment.

FIG. 16 is a flowchart of processing of selecting a plurality of pieces of TTS reference data by the database according to the embodiment.

FIG. 17 is an explanatory diagram of the number of pieces of reference data according to variance of the embodiment.

FIG. 18 is an explanatory diagram of a display example by the information terminal according to the embodiment.

FIG. 19 is a block diagram of an information processing apparatus according to the embodiment.

### MODE FOR CARRYING OUT THE INVENTION

Hereinafter, an embodiment will be described in the following order.
<1. System Configuration>
<2. Operation of TTS Speaker Suggestion System>
<3. Processing by Content Analysis Server>
<4. Processing by Voice Synthesis Server>
<5. Processing by Database>
<6. Display by Information Terminal>
<7. Coping with Case Where There Is Plurality of Speakers in Reference Content>
<8. Suggestion of Plurality of Speaker Candidates>
<9. Configuration of Information Processing Apparatus>
<10. Summary and Modifications>

### 1. System Configuration

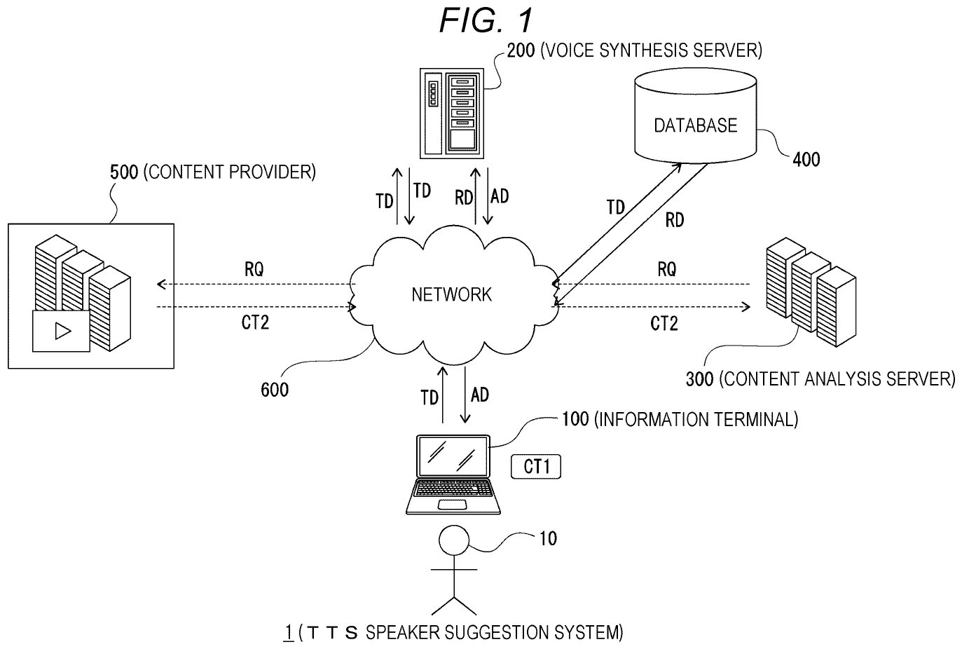

FIG. 1 illustrates a configuration example of a TTS speaker suggestion system 1 according to the embodiment. The TTS speaker suggestion system 1 is a system that suggests, to a user 10, a TTS speaker appropriate for text of content CT1 produced by an information terminal 100, for example.

In the TTS speaker suggestion system 1, devices such as the information terminal 100, a voice synthesis server 200, a content analysis server 300, a database 400, and a content provider 500 are connected to each other via a network 600.

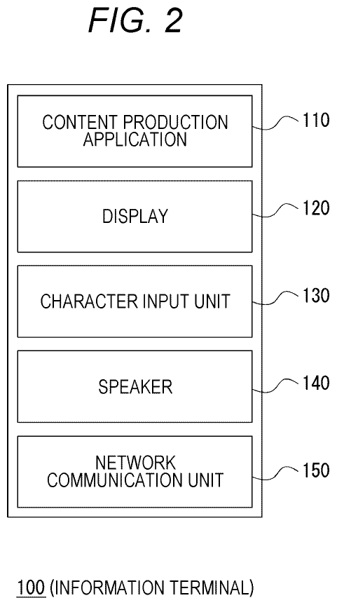

The user 10 operates the information terminal 100 to produce the content CT1. Note that, in the present disclosure, the “content CT1” is a work mainly using voice, regardless of the presence or absence of video (moving image or still image). The information terminal 100 has functions illustrated in FIG. 2 for content production.

A content production application 110 is a function of performing production and editing of the content CT1 according to operation by the user 10.

A display 120 is a function of performing video display for the user 10.

A character input unit 130 is an input function for the user 10 to perform text data input to, for example, the content CT1.

A speaker 140 is a function of performing voice output to the user 10.

A network communication unit 150 is a function of performing communication with other devices via the network 600.

The information terminal 100 is connected to the network 600 such as the Internet through the network communication unit 150, and can obtain synthesized voice data AD by transmitting text data TD to the voice synthesis server 200.

The text data TD to be transmitted is input by the user 10 in a production processing process by the content production application 110. For example, the user 10 inputs the text data TD by using the character input unit 130.

The voice synthesis server 200 has a role of converting the text data TD transmitted from the information terminal 100 into the synthesized voice data AD.

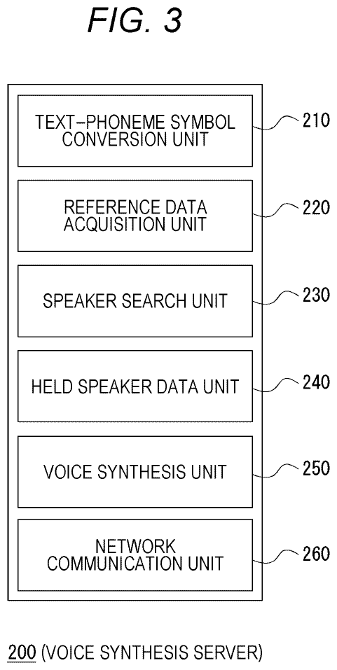

For this purpose, as illustrated in FIG. 3, the voice synthesis server 200 includes a text-phoneme symbol conversion unit 210, a reference data acquisition unit 220, a speaker search unit 230, a held speaker data unit 240, a voice synthesis unit 250, and a network communication unit 260.

The voice synthesis server 200 is connected to the network 600 through the network communication unit 260. The voice synthesis server 200 receives the text data TD transmitted from the information terminal 100.

The text-phoneme symbol conversion unit 210 in the voice synthesis server 200 is a function of converting the text data TD into phoneme data. A phoneme is a symbol representing each of individual sounds of voice. By this function, the voice synthesis server 200 generates phoneme data according to the text data TD transmitted from the information terminal 100.

The reference data acquisition unit 220 is a function of acquiring TTS reference data RD from the database 400. The TTS reference data RD is data used to generate the synthesized voice data AD suitable for the content CT1. The reference data acquisition unit 220 transmits the text data TD transmitted from the information terminal 100 to the database 400, and requests the TTS reference data RD suitable for the content CT1 from the database 400.

The speaker search unit 230 is a function of searching for speaker data having a voice (voice feature amount) similar to a voice feature amount RDX among pieces of speaker data held by the voice synthesis server 200 by using the voice feature amount RDX in the TTS reference data RD transmitted from the database 400.

The held speaker data unit 240 is a function of storing speaker data for which the speaker search unit 230 searches. The speaker data includes a speaker ID for identifying each of pieces of speaker data and data of a voice quality associated with the speaker ID.

The voice synthesis server 200 selects any of the plurality of pieces of speaker data stored in the held speaker data unit 240 and suggests selected data to the user 10.

The voice synthesis unit 250 is a function of generating the synthesized voice data AD from the text data TD. The voice synthesis unit 250 generates the synthesized voice data AD corresponding to the text data TD on the basis of the speaker data selected by the speaker search unit 230 and the phoneme data obtained by the text-phoneme symbol conversion unit 210.

Note that the text-phoneme symbol conversion unit 210 is also called grapheme-phoneme conversion (G2P). The voice synthesis unit 250 generally includes components called a “synthesizer” and a “vocoder” (not illustrated).

The voice synthesis server 200 sends out the generated synthesized voice data AD to the network 600 by using the network communication unit 260. Thereafter, the synthesized voice data AD goes through the network communication unit 150 of the information terminal 100 and is used by the content production application 110.

The content analysis server 300 illustrated in FIG. 1 performs analysis of content CT2 provided by the content provider 500. The content CT2 is generally distributed and broadcasted content, and is denoted as “reference content CT2” in order to be distinguished from the content CT1. The reference content CT2 also refers to a work in which voice is recorded, and the presence or absence of video does not matter.

The TTS reference data RD is generated by analysis of the reference content CT2 by the content analysis server 300, and the voice synthesis server 200 uses the TTS reference data RD during voice synthesis.

An object of the present embodiment is to provide a voice quality suitable for the text data TD input by the user 10, that is, a synthesized voice suitable for detail of the content CT1. In order to achieve this, it is a role of the content analysis server 300 to prepare information regarding voice suitable as a voice quality of reading the text data TD.

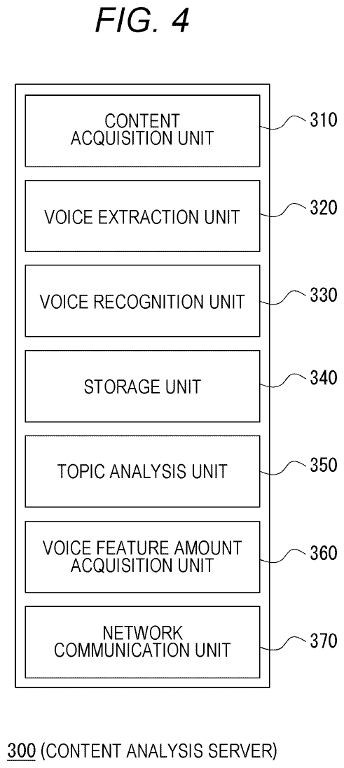

As illustrated in FIG. 4, the content analysis server 300 includes a content acquisition unit 310, a voice extraction unit 320, a voice recognition unit 330, a storage unit 340, a topic analysis unit 350, a voice feature amount acquisition unit 360, and a network communication unit 370.

The content analysis server 300 can communicate with the content provider 500, the database 400, and the like via the network communication unit 370.

The content acquisition unit 310 is a function of acquiring the reference content CT2 to be analyzed. The content acquisition unit 310 transmits an acquisition request RQ to the content provider 500 via the network communication unit 370, and acquires various types of reference content CT2. As the reference content CT2, for example, it is conceivable to download a public domain internet radio. Alternatively, this can also be achieved by individually requesting the content provider 500 to provide a content acquisition application programming interface (API).

The voice extraction unit 320 extracts voice of the reference content CT2 acquired from the content provider 500. It is possible to extract the voice in a case where the reference content CT2 is a moving image by using existing software.

The voice recognition unit 330 converts the voice of the reference content CT2 extracted by the voice extraction unit 320 into text data, that is, an utterance sentence TR.

The storage unit 340 stores the utterance sentence TR.

The topic analysis unit 350 performs discrimination of a topic vector RDT for the text data transcribed by the voice recognition unit 330. The topic vector RDT is information expressing a topic of content (text data). Thus, it can be said that the topic vector RDT is information serving as an index of classification of topics.

Note that the topic is a term indicating what the detail of the text data is, such as a subject or a genre. For example, if a movie is taken as an example, a subject, a genre of the subject, and the like are collectively referred to as topics, such as a subject of a specific movie, a subject of the entire movie world, “action movie” and “comedy movie” and the like as genres.

The voice feature amount acquisition unit 360 converts voice data of the reference content CT2 extracted by the voice extraction unit 320 into the voice feature amount RDX called “x-vector”.

With the above function, the content analysis server 300 can obtain, for the reference content CT2
the topic vector RDT
the voice feature amount RDX, and
a URL (RDU) of the content. These pieces of information are collected into one piece of the TTS reference data RD, and stored in the database 400 via the network 600.

In response to an inquiry from the voice synthesis server 200, the database 400 performs a search for a voice feature amount of a voice quality suitable for reading the text data TD. For the search, the TTS reference data RD analyzed by the content analysis server 300 is used.

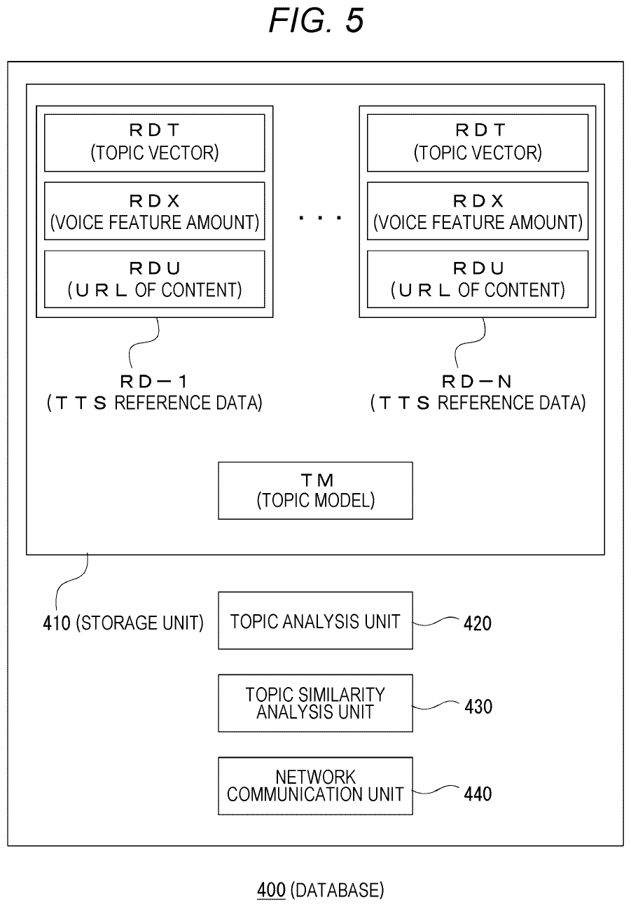

As illustrated in FIG. 5, the database 400 includes a storage unit 410, a topic analysis unit 420, a topic similarity analysis unit 430, and a network communication unit 440.

The database 400 can communicate with the content analysis server 300, the voice synthesis server 200, and the like via the network communication unit 440.

The storage unit 410 stores the TTS reference data RD for various types of the reference content CT2. The drawing illustrates a state in which N pieces of the TTS reference data RD are stored as TTS reference data RD-1 to TTS reference data RD-N.

One piece of the TTS reference data RD includes the topic vector RDT, the voice feature amount RDX, and the URL (RDU) of the reference content CT2.

The topic analysis unit 420 is a function of converting the text data TD transmitted from the voice synthesis server 200 into a topic vector TV.

The topic similarity analysis unit 430 is a function of searching for the TTS reference data RD having the highest similarity with the topic vector TV, among the topic vectors RDT of the TTS reference data RD stored in the storage unit 410.

The content provider 500 illustrated in FIG. 1 is a provider that provides the reference content CT2. For example, a moving image posting site or the like corresponds to the content provider 500. The content provider 500 is not limited to one provider, and may include a plurality of companies and services. Furthermore, the reference content CT2 to be provided is not limited to a moving image, and may be voice-only content provided by an internet radio.

### 2. Operation of TTS Speaker Suggestion System

Operation of the TTS speaker suggestion system 1 having the above configuration will be described.

First, an operation purpose of the TTS speaker suggestion system 1 according to the embodiment will be described.

The TTS speaker suggestion system 1 performs operation for providing a voice having a voice quality suitable for the content CT1 to the user 10 who produces the content CT1.

It is necessary to adopt a voice according to the detail of the content CT1 for a narration or a speech of the content CT1. If voices of a large number of voice qualities are provided for the text of the content CT1, choices of the user 10 are widened, but selection itself becomes troublesome. Furthermore, even if the selection can be made according to the level of the frequency of the voice, the gender or the age of the speaker, the voice image, or the like, it may not necessarily match the detail of the content CT1.

Thus, in the TTS speaker suggestion system 1 according to the present embodiment, a synthesized voice is generated having a voice quality close to that of a narrator or an actor appearing in the reference content CT2 provided by the content provider 500, whereby a TTS speaker suitable for the detail of the content CT1 being produced is suggested to the user 10.

By reading the narration or the speech of the content CT1 with a voice close to a speaker appearing in the reference content CT2 for which trial listening is widely performed in the world, it can be expected that a sense of incongruity with respect to atmosphere of the voice of the synthesized voice is not given to viewers.

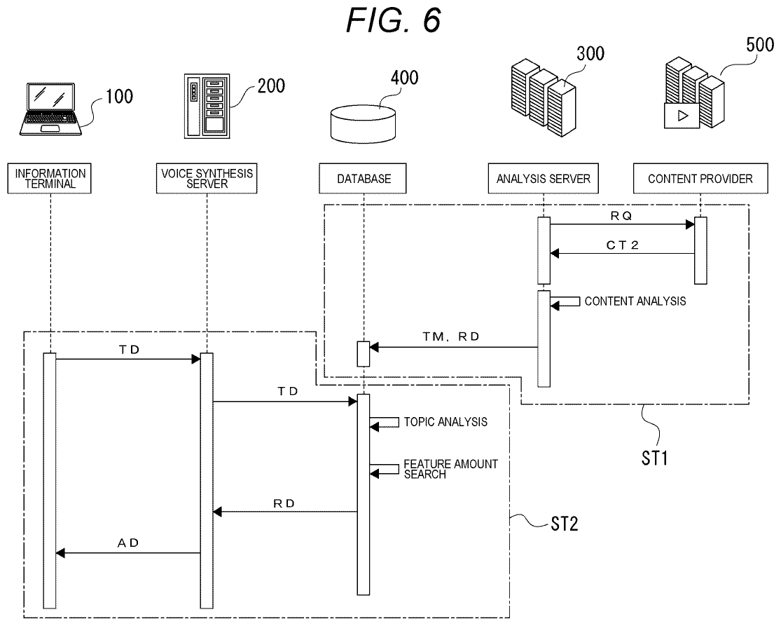

A flow of operation of each device of the TTS speaker suggestion system 1 will be described with reference to FIG. 6.

First, as precondition processing for suggesting the TTS speaker to the user 10, processing ST1 is performed in which the content analysis server 300 generates a topic model TM and the TTS reference data RD and stores the topic model TM and the TTS reference data RD in the database 400.

In order for the voice synthesis server 200 to generate the synthesized voice data AD by a speaker suitable for a genre or topic of the content CT1, the TTS reference data RD is required. For that reason, the content analysis server 300 performs analysis of the reference content CT2, and prepares the TTS reference data RD in the database 400. The processing ST1 is only required to be sequentially and continuously performed on various types of the reference content CT2. That is, it is not necessary to synchronize with processing ST2 for speaker suggestion to the user 10 (information terminal 100).

As the processing ST1, the content analysis server 300 transmits the acquisition request RQ to the content provider 500. In response to this, the content provider 500 transmits the reference content CT2 to the content analysis server 300.

When acquiring the reference content CT2, the content analysis server 300 analyzes the acquired reference content CT2 and generates the topic model TM and the TTS reference data RD. Then, these are transmitted to and stored in the database 400.

The content analysis server 300 can monitor distribution of the reference content CT2 provided by the content provider 500 and appropriately perform the processing ST1 described above to generate the TTS reference data RD. By mainly analyzing the reference content CT2 that is popular, it can be expected to obtain the TTS reference data RD for suggesting, to the user 10, a voice quality more widely accepted by people.

Next, the processing ST2 will be described. The processing ST2 is executed in response to transmission of the text data TD from the information terminal 100 by the user 10.

The information terminal 100 transmits the text data TD to the voice synthesis server 200. The text data TD is, for example, data of a sentence as the narration or the speech of the content CT1 produced by the user 10.

The voice synthesis server 200 transmits the received text data TD to the database 400.

The database 400 performs “topic analysis” and “voice feature amount search” on the received text data TD, and selects one or a plurality of pieces of the TTS reference data RD suitable for the text data TD. Then, the database 400 transmits the TTS reference data RD obtained by these pieces of processing to the voice synthesis server 200.

Using the voice feature amount RDX in the TTS reference data RD received from the database 400, the voice synthesis server 200 performs comparison with a voice feature amount of a held speaker held in the held speaker data unit 240 in the voice synthesis server 200, and selects speaker data having the most similar voice quality.

Then, the voice synthesis server 200 performs voice synthesis processing on the text data TD by using a voice synthesis model of the speaker data to generate the synthesized voice data AD. The voice synthesis server 200 transmits the synthesized voice data AD to the information terminal 100.

The information terminal 100 advances work of incorporating the synthesized voice data AD received by the user 10 into the content CT1 being produced, by using the content production application 110.

As described above, the TTS speaker suggestion system 1 suggests, to the user 10, the synthesized voice data AD having a voice quality suitable for the narration, the speech, or the like of the content CT1.

Here, the topic analysis and the voice feature amount will be described.

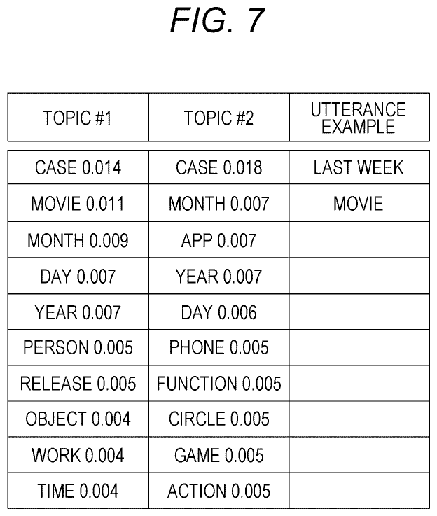

First, the topic analysis will be described. FIG. 7 illustrates information (defined as a topic model) generated on the basis of some pieces of reference content CT2.

In the example of FIG. 7, in order to simplify the description, genre classification is performed in two topics #1 and #2. For genre classification, “Latent Dirichlet Allocation (LDA)” is used. In the topic #1, an appearance probability of a word related to “movie” is high. It can be seen that a word related to “smartphone” appears in the topic #2. In this example, 10 words having a high appearance probability are displayed in order of appearance probability.

This topic model is used to examine which topic a certain utterance belongs to.

For example, it is assumed that the utterance is “I watched a movie last weekend”.

When word separation is performed on this utterance, the following word separation word string is obtained. When only nouns are left in the word string, a noun word string is obtained.
Word separation word string=[‘I’, ‘watched’, ‘a’, ‘movie’, ‘last’ ‘weekend’]
Noun word string=[‘weekend’, ‘movie’]

When topic analysis is performed on the noun word string by using the LDA, a topic vector below is obtained. Here, the topic vector is defined to represent a probability distribution of which topic a certain utterance text is classified into.
Topic #1:0.8, Topic #2:0.2
Topic Vector=[0.8, 0.2]

The above utterance has a high appearance probability related to the topic #1, and it can be determined that the subject of the utterance is along the topic #1.

Such a topic model is generated by the content analysis server 300 and used in processing by the database 400.

Next, the voice feature amount will be described.

A voice quality of a speaker appearing in the reference content CT2 and a voice quality of a speaker model held in the voice synthesis server 200 are compared with each other by use of a feature amount called “x-vector”. The “x-vector” is also called “deep speaker embedding”, and is a type of “speaker identification technology” using a deep learning technology. Typically, the x-vector is a 512-dimensional vector.

How to use the x-vector will be described.

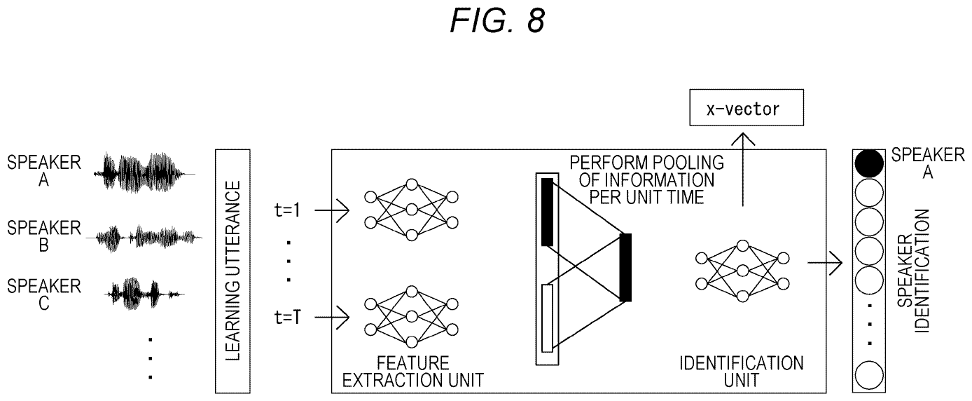

FIG. 8 illustrates a learning process of the x-vector. Voices of a plurality of speakers such as a speaker A, a speaker B, a speaker C, and the like are input to a neural network. In each voice, a feature amount of the voice is extracted for each unit time width from t=1 to t=T.

These feature amounts are subjected to max pooling. The max pooling is processing of selecting a maximum value from input data while sliding a window of a certain size, and this makes it possible to reduce the input data.

The feature amounts subjected to the max pooling are subjected to speaker class determination by an identification unit, and learning of the speakers is performed.

A part of the identification unit obtained by the learning can be used as the x-vector. For example, the x-vector obtained when the voice of the speaker A is input can be considered as a kind of voiceprint of the speaker A.

Furthermore, the neural network can be applied to a speaker other than the speakers used for the learning. Thus, it is possible to obtain the x-vector of a speaker of each of pieces of content by inputting voices of a narrator or a performer in the reference content CT2 to the neural network. Similarly, it is possible to obtain x-vectors of speakers by inputting voices of the speakers of the voice synthesis server 200 to the neural network.

By comparing x-vectors of two speakers with each other, it is possible to determine whether the voices are similar to each other. As a voice similarity, for example, a cosine similarity between vectors or collation by probabilistic linear discriminant analysis (PLDA) can be used.

### 3. Analysis Processing in Content Analysis Server

The processing by the content analysis server 300 in the processing ST1 of FIG. 6 will be described.

There are two model creation phases as processing by the content analysis server 300.

First, there is a phase of creating a topic model. Next, there is a phase of examining which topic each of pieces of reference content CT2 corresponds to and creating the TTS reference data RD.

A topic model creation phase will be described.

The content analysis server 300 collects a plurality of pieces of the reference content CT2 from the content provider 500, and creates a topic model from utterance text in the reference content CT2 by the LDA. An object of this is to perform genre classification of the reference content CT2 provided by the content provider 500.

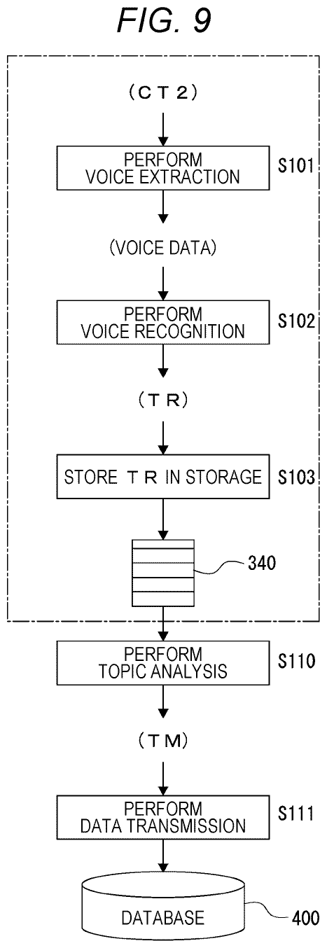

This will be described with reference to FIGS. 4 and 9. Note that FIG. 9 is a flowchart of processing performed by a processor as the content analysis server 300, and the processing to be executed is indicated by a solid line box, and data input or output to the processing is indicated by a character or a sign in ( ) for easy understanding. Furthermore, the storage unit 340 and the database 400 as data storage destinations are also illustrated. The processing performed by the processor as the content analysis server 300 is denoted by a step number.

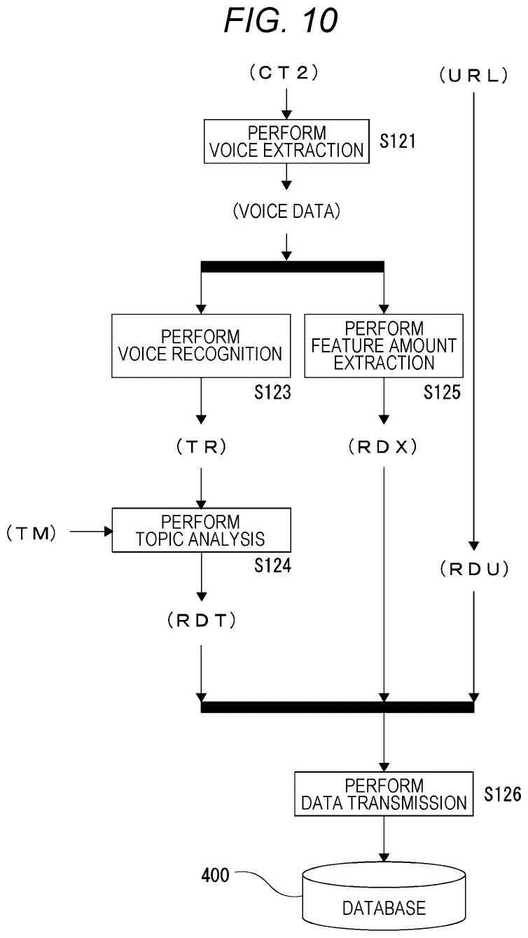

Such a description format of a flowchart is similarly used in FIGS. 10, 11, 12, 14, 15, and 16 to be described later.

The content analysis server 300 acquires the reference content CT2 from the content provider 500 by the content acquisition unit 310.

In step S101, the voice extraction unit 320 performs processing of extracting voice data on the acquired reference content CT2.

The extracted voice data is subjected to voice recognition processing by the voice recognition unit 330 in step S102, and is converted into the utterance sentence TR that is text data.

The utterance sentence TR is stored in the storage unit 340 in step S103.

Note that the processing in steps S101, S102, and S103 surrounded by a one-dot chain line is repeatedly performed on a plurality of pieces of the reference content CT2.

Then, the processing in steps S101, S102, and S103 is performed on a predetermined number (M) of pieces of the reference content CT2, and when the number of utterance sentences TR stored in the storage unit 340 becomes M, the topic analysis unit 350 performs topic analysis in step S110 by using the stored M utterance sentences TR. As a result, the topic model TM is obtained.

The generated topic model TM is transmitted to the database 400 through the network communication unit 370 in step S111.

Next, a TTS reference data RD creation phase will be described.

In this phase, an object is to create the TTS reference data RD indicating what topic vector a certain reference content CT2 has, what feature voice the voice used in the reference content CT2 is, and in which uniform resource locator (URL) the voice is present.

This will be described with reference to FIGS. 4 and 10.

In the content analysis server 300, in step S121, extraction of voice data is performed by the voice extraction unit 320 for the reference content CT2 acquired by the content acquisition unit 310.

The extracted voice data is subjected to voice recognition processing by the voice recognition unit 330 in step S123, and the utterance sentence TR is obtained.

The utterance sentence TR is subjected to topic analysis by the topic analysis unit 350 in step S124. As a result, the topic vector RDT is obtained. The topic vector RDT is a vector of a probability of which topic the utterance sentence TR belongs to.

At the time of processing of the topic analysis, the topic model TM obtained in the topic model creation phase of FIG. 9 is used.

The voice data extracted in step S121 is also used in step S125, and the voice feature amount RDX is obtained by the voice feature amount acquisition unit 360.

In step S126, the content analysis server 300 combines the topic vector RDT and the voice feature amount RDX obtained as described above, and the URL (RDU) of the reference content CT2 into one piece of the TTS reference data RD, and transmits the TTS reference data RD to the database 400. As a result, the TTS reference data RD is additionally stored in the database 400.

Note that, in the description here, the utterance sentence TR is extracted again from the reference content CT2 in step S123, but the utterance sentence TR generated in step S102 of the topic model creation phase in FIG. 9 may be cached and used.

### 4. Processing by Voice Synthesis Server

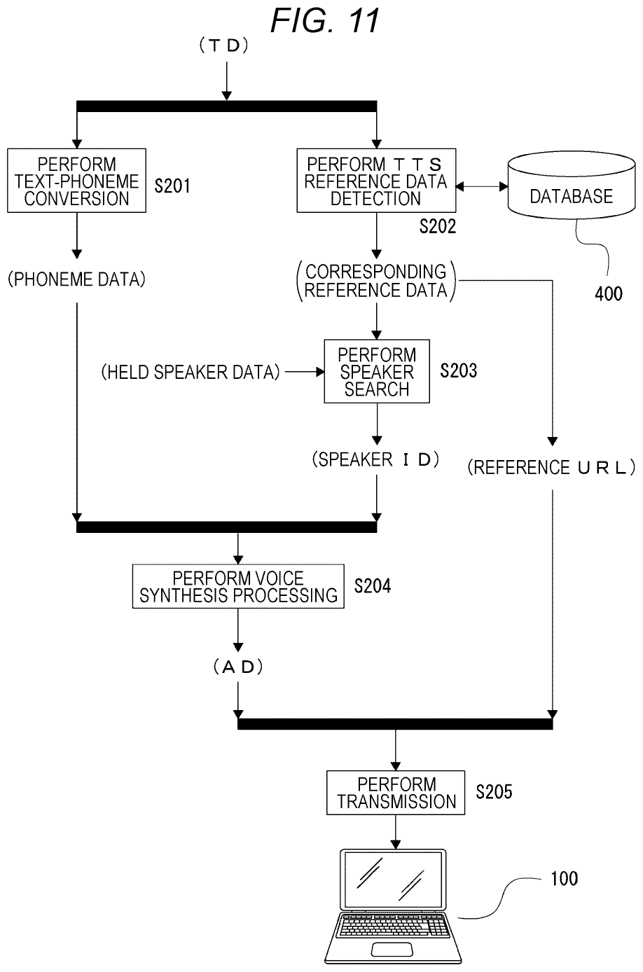

Next, processing by the voice synthesis server 200, particularly how the TTS reference data RD is used at the time of voice synthesis will be described with reference to FIGS. 3 and 11.

The user 10 inputs the text data TD to be made into synthesized voice by using the content production application 110 used in the information terminal 100. The text data TD is a so-called natural sentence and does not need to be a special sentence prepared for the TTS speaker suggestion system 1. Thus, the user 10 does not need to learn a special description method to use the TTS speaker suggestion system 1.

The voice synthesis server 200 performs processing in FIG. 11 by receiving the text data TD.

In step S201, the voice synthesis server 200 that has received the text data TD performs processing of converting a natural sentence into phoneme data for voice synthesis by the text-phoneme symbol conversion unit 210.

Furthermore, the voice synthesis server 200 performs processing of acquiring the TTS reference data RD by the reference data acquisition unit 220 in step S202. Specifically, the voice synthesis server 200 transmits the text data TD to the database 400, and makes a search request for the TTS reference data RD. In response to this, the database 400 receives the text data TD as an input, and selects the TTS reference data RD having the topic vector RDT closest to the topic vector of the text data TD among the TTS reference data RD stored in the database 400, and transmits the selected TTS reference data RD to the voice synthesis server 200. The processing by the database 400 will be described later.

The voice synthesis server 200 receives the TTS reference data RD selected in this way in the database 400, that is, corresponding reference data with respect to the text data TD.

The voice synthesis server 200 that has received the TTS reference data RD as the corresponding reference data from the database 400 performs a speaker search by the speaker search unit 230 in step S203.

In this case, the voice synthesis server 200 uses the voice feature amount RDX included in the TTS reference data RD to calculate a speaker having a similar voice quality among speaker models held in the held speaker data unit 240.

Specifically, by calculating a cosine similarity between the voice feature amount RDX sent from the database 400 and the voice feature amount of the held speaker model, it is possible to obtain a speaker having a similar voice quality. With this processing, it is possible to derive a speaker ID of the speaker data most appropriate for the present topic among the speaker models held by the voice synthesis server 200.

The voice synthesis server 200 obtains the synthesized voice data AD by inputting the phoneme data obtained in step S201 and the speaker ID obtained in step S203 to the voice synthesis unit 250.

Then, in step S205, the voice synthesis server 200 performs processing of transmitting the synthesized voice data AD, the speaker ID, and a reference URL to the information terminal 100 by the network communication unit 260. The reference URL is the URL (RDU) of the reference content CT2 included in the TTS reference data RD acquired in step S202.

### 5. Processing by Database

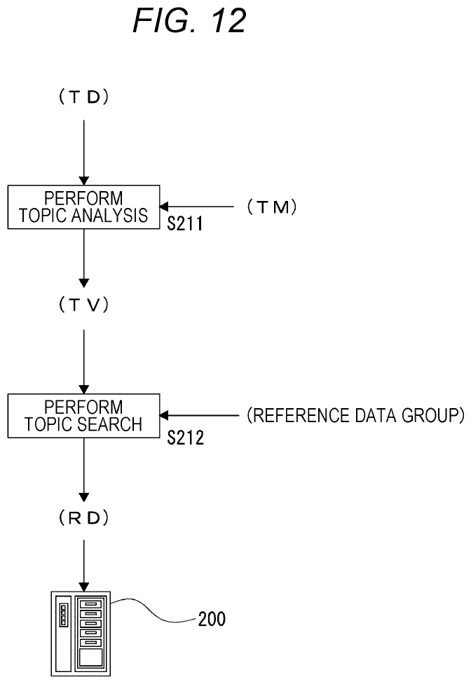

Processing by the database 400 will be described with reference to FIGS. 5 and 12. This is processing according to the search request from the voice synthesis server 200 in step S202 in FIG. 11 described above.

Upon receiving the text data TD from the voice synthesis server 200, the database 400 performs topic analysis by the topic analysis unit 420 in step S211 of FIG. 12.

In the topic analysis, the topic analysis of the text data TD is performed by using the topic model TM stored in the storage unit 410, and the topic vector TV is generated.

Next, in step S212, the database 400 performs a topic search by the topic similarity analysis unit 430. This is processing of searching for the topic vector RDT similar to the topic vector TV. Specifically, the processing is processing of searching for the TTS reference data whose topic vector RDT is similar to the topic vector TV of the text data TD among pieces of the TTS reference data RD (RD-1 . . . . RD-N) generated from various types of the reference content CT2 stored in the storage unit 410.

The fact that the topic vectors are similar to each other corresponds to the fact that the genres are the same as each other or the subjects are similar to each other, as content detail.

That is, searching for the TTS reference data RD having a similar topic vector can also be said to be searching for the TTS reference data RD generated on the basis of the reference content CT2 having a similar genre or subject to the content CT1 produced by the user 10.

The cosine similarity can be used to search for the topic vector RDT similar to the topic vector TV. As a result, the TTS reference data RD having the topic vector RDT having the highest similarity with the topic vector TV is selected as an optimal topic among the plurality of pieces of the TTS reference data RD.

Then, the database 400 transmits the TTS reference data RD obtained as the optimal topic to the voice synthesis server 200 as corresponding reference data with respect to the text data TD of this time.

Note that a threshold may be provided for the similarity, and in a case where the similarity does not exceed the threshold, the plurality of pieces of the TTS reference data RD may be transmitted to the voice synthesis server 200.

### 6. Display by Information Terminal

A display example will be described performed for the user 10 by the information terminal 100 as a result of the above processing.

Data received by the information terminal 100 from the voice synthesis server 200 is the synthesized voice data AD and the URL of the reference content CT2.

The URL of the reference content CT2 is provided to indicate, to the user 10, information regarding in what content the voice of the speaker was used as a reference in generating synthesized voice.

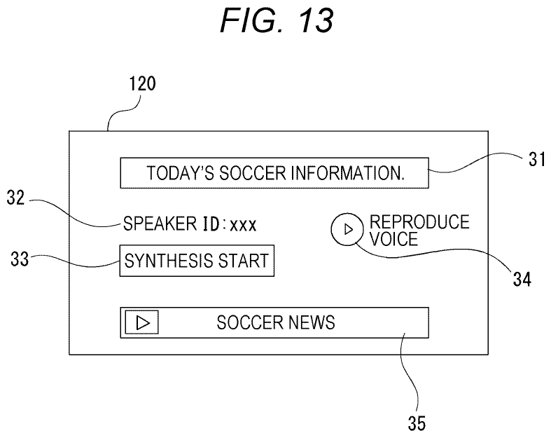

FIG. 13 illustrates a display example by the display 120 of the information terminal 100. The display 120 displays thereon a text box 31, a speaker ID 32, a synthesis start button 33, a reproduction button 34, and a reference URL 35.

The text box 31 is a box for inputting the text data TD.

The speaker ID 32 is the speaker ID selected by the voice synthesis server 200 in step S203 of FIG. 11.

The synthesis start button 33 is an operation element that gives an instruction to start the voice synthesis processing.

The reproduction button 34 is an operation element for reproducing the synthesized voice.

The reference URL 35 is the URL of the reference content CT2 whose voice was used as a reference, and is displayed in the form of a link to the reference content CT2, for example.

The user 10 can listen to a voice of a speaker with the speaker ID 32 suggested from the voice synthesis server 200 by operating the reproduction button 34 on this screen.

Furthermore, when the reference URL 35 is operated, the voice synthesis server 200 reproduces the reference content CT2 used as a reference when selecting the speaker ID 32, and it is possible to listen to the voice such as the narration.

Thus, the user 10 can not only listen to a read voice of text by a speaker ID suggested from the voice synthesis server 200, but also listen to a voice in the reference content CT2 whose genre and the like are similar to those of the content CT1 being produced, for selection of the speaker ID.

### 7. Coping with Case Where There Is Plurality of Speakers in Reference Content

So far, the description has been given assuming that only one speaker appears in each of pieces of reference content CT2. However, a plurality of speakers usually appears in the actual reference content CT2. For example, in a television program or the like, a different announcer is often responsible for each genre such as a report from a site, a weather forecast, traffic information, and sports information.

Although the x-vector that is the feature amount expressing the voice has been described with respect to the voice feature amount, it is possible to detect that the speaker is changed in the reference content CT2 by using the x-vector. This is a technology called “speaker diarization”, and by using this technology, the present technology can cope with a case where there is a plurality of speakers in one piece of content.

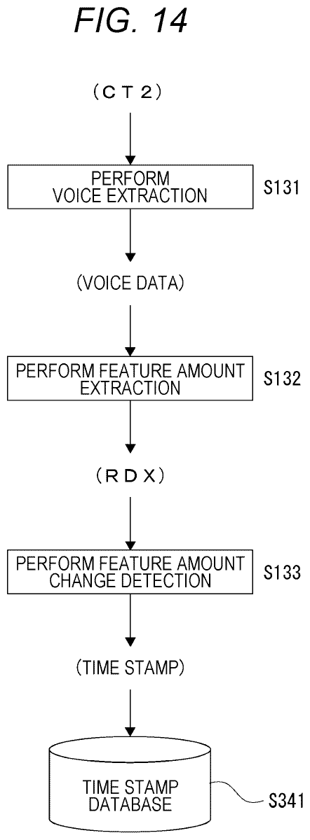

This will be described with reference to FIG. 14.

The content analysis server 300 performs voice extraction by the voice extraction unit 320 for the reference content CT2 in step S131 to acquire voice data.

Next, in step S132, the voice feature amount acquisition unit 360 extracts the voice feature amount RDX every certain unit time, for example, 30 seconds. Feature amount change detection processing is performed in step S133 on the voice feature amount RDX for each of the unit time, and a change greater than or equal to a threshold is monitored.

It is possible to use the cosine similarity for detection of a feature amount change. If there is a change greater than or equal to the threshold, it means that the speaker has changed, so a time stamp is recorded and stored in a time stamp database 341.

The time stamp database 341 is prepared using, for example, a partial area of the storage unit 340.

The content analysis server 300 monitors a change in the voice feature amount RDX for the reference content CT2 and stores a change point, as described above, for example.

As a result, it is also possible to cope with the reference content CT2 in which a plurality of speakers appears with a configuration equivalent to that of the system described in the TTS reference data creation phase of FIG. 10.

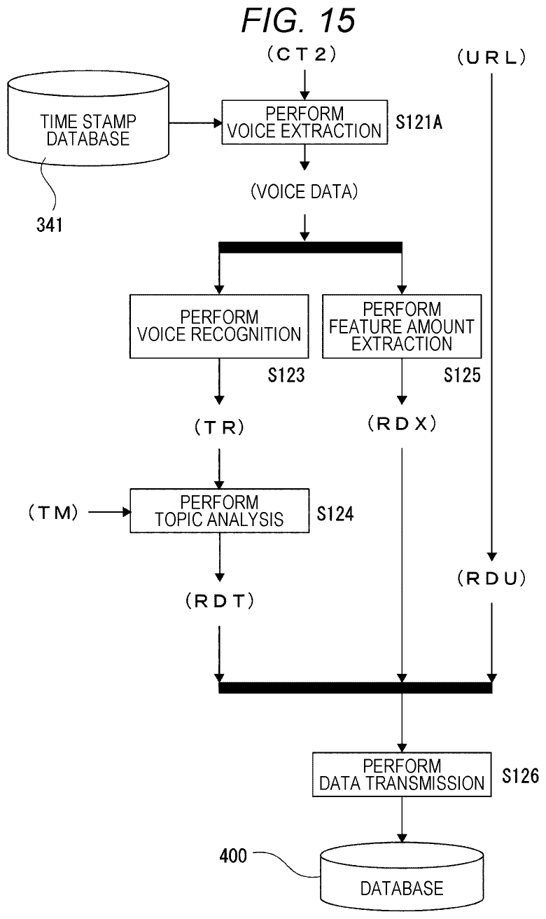

For example, FIG. 15 illustrates processing in a TTS reference data creation phase similar to that in FIG. 10. Note that the same processing as that in FIG. 10 is denoted by the same step number, and description thereof is omitted.

In the case of FIG. 15, in step S121A, voice extraction is performed for each of sections determined by the time stamp, for the reference content CT2, by use of the time stamp database 341.

Thereafter, processing similar to that in FIG. 10 is performed for the extracted voice data to generate the TTS reference data RD.

### 8. Suggestion of Plurality of Speaker Candidates

In the above description, it has been described that one speaker optimal for the content CT1 is suggested from words (text data TD) spoken in the content CT1.

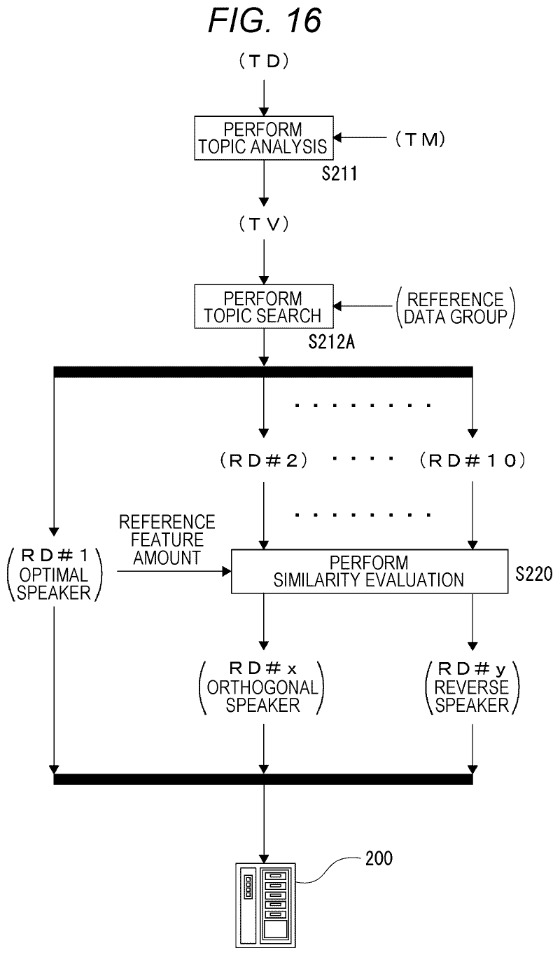

On the other hand, it is considered that some users 10 may wish to try other speakers as choices. A processing example of providing a plurality of speakers assuming such users 10 will be described with reference to FIG. 16. Note that, in FIG. 16, the same processing as that in FIG. 12 is denoted by the same step number to avoid redundant description.

In FIG. 12 described above, the TTS reference data RD for which the topic similarity analysis unit 430 searches in step S212 is only one having the most similar topic vector.

In step S212A of FIG. 16, in order to increase the number of voice types to be suggested, a plurality of pieces of the TTS reference data RD for which the topic similarity analysis unit 430 searches is selected in descending order of the cosine similarity. In the drawing, 10 pieces are selected, and 10 pieces of the TTS reference data RD (RD #1 to RD #10) are illustrated.

The TTS reference data RD #1 having the topic vector RDT with the highest similarity is set as data of an “optimal speaker”, and the reference data #2, . . . , and reference data #10 are set in descending order of the similarity.

Here, the cosine similarity will be described again.

In the above description of the voice feature amount, it has been described that the x-vector can be used as the voiceprint of the speaker. The cosine similarity was then used to examine similar voices. In FIG. 11, it has been described that the voice synthesis server 200 obtains the TTS reference data RD on the basis of the text data TD transmitted from the information terminal 100. Then, the TTS reference data RD includes the voice feature amount RDX that is the x-vector.

Since the voice feature amount RDX is a vector, it is possible to calculate a similarity of a voice quality by calculating a cosine similarity with another voice feature amount.

For example, a cosine similarity of two vectors a and b can be expressed by (Math. 1), and ranges from “−1” to “1”.

$$Cosine similarity : cos ( a , b ) = \frac{a \cdot b}{‖ a ‖ ‖ b ‖} \qquad [ Math . 1 ]$$

When the cosine similarity is “1”, the vectors form an angle of 0 degrees and are in the same direction. That is, this is a relationship of completely similar voice quality.

When the cosine similarity is “0”, the vectors form an angle of 90 degrees and are in directions orthogonal to each other. That is, it can be said that the vectors have no relationship with both the fact that the voice qualities are similar to each other and the fact that the voice qualities are not similar to each other.

When the cosine similarity is “−1”, the vectors form an angle of 180 degrees and are in opposite (reverse) directions. This is a completely dissimilar voice quality relationship.

In the processing in FIG. 16, the database 400 performs similarity evaluation processing in step S220 using a plurality of (for example, 10) pieces of the TTS reference data RD (RD #1 to RD #10).

In this similarity evaluation processing, the voice feature amount RDX of the TTS reference data RD #1 of the optimal speaker is set as a “reference feature amount”, and the cosine similarity is obtained between the reference feature amount and each of voice feature amounts RDX included in the TTS reference data RD #2 to the TTS reference data RD #10.

In this case, the TTS reference data RD having the voice feature amount RDX whose cosine similarity with the reference feature amount is close to “0” is information on a speaker having a feature that is neither similar to nor dissimilar to the optimal speaker. Such TTS reference data RD #x is referred to as an “orthogonal speaker”.

The TTS reference data RD having the voice feature amount RDX whose cosine similarity with the reference feature amount is close to “−1” is information on a speaker having a feature not similar to the optimal speaker. Such TTS reference data RD #y is referred to as a “reverse speaker”.

The TTS reference data RD #1 of the optimal speaker, the TTS reference data RD #x of the orthogonal speaker, and the TTS reference data RD #y of the reverse speaker are collected as one data group and transmitted to the voice synthesis server 200.

In step S203 of FIG. 11, the voice synthesis server 200 searches for speaker data similar to the TTS reference data RD among the pieces of speaker data held in the held speaker data unit 240, but in this case, searches for speaker data similar to each of pieces of the TTS reference data RD #1, RD #x, and RD #y.

Thus, a speaker ID of a speaker similar to the optimal speaker, a speaker ID of a speaker similar to the orthogonal speaker, and a speaker ID of a speaker similar to the reverse speaker are obtained.

As a result, three voices having different voice qualities are suggested to the user 10.

Note that, in the above example, two voice feature amounts RDX having cosine similarities close to “0” and “−1” are obtained, but it is also possible to obtain a plurality of voice feature amounts having cosine similarities from “−1” to “1”.

Suggesting the reference data having the cosine similarity of orthogonal or opposite direction to the user 10 from pieces of the reference data having higher similarities of the topic vector in this way means searching for the reference content CT2 having a similar topic but a different voice quality of the speaker and suggesting a voice quality similar to those voice qualities to the user 10.

Furthermore, it is also conceivable to change the number of speakers suggested to the user 10 depending on variance of the voice feature amounts.

The next (Math. 2) is a matrix of the cosine similarity between the reference feature amount (the voice feature amount RDX of the optimal speaker) and the voice feature amounts RDX of the other pieces of the TTS reference data RD.

Cosine similarity matrix=[s1,2 s1,3 s1,4 s1,5 s1,6 s1,7 s1,8 s1,9 s1,10] [Math. 2]

Here, s1,i represents a cosine similarity between the reference feature amount and the i-th feature amount.

Variance σ² of this matrix is shown in (Math. 3). The symbol μ is an average value.

$${σ}^{2} = \frac{{\sum }_{i = 1}^{n} {( s 1 , ( i + 1 ) - μ )}^{2}}{n} \qquad [ Math . 3 ]$$

By obtaining the variance, it is possible to obtain a guideline of whether the suggested speaker converges to one voice feature amount or is scattered among a plurality of speakers.

Here, n is the number of pieces of the TTS reference data RD for which the similarity is evaluated. In the case of (Math. 2), the number is n=9. In a case where 10 pieces of the TTS reference data RD (RD #1 to RD #10) are first selected, the similarity is evaluated of the TTS reference data RD #2 to RD #10 with respect to the TTS reference data RD #1, and thus the number is n=9.

For example, in a case where the variance is close to zero, the voice qualities of the speakers of the topic are approximately similar to each other. In that case, by increasing the number of pieces of reference data for which the similarity is evaluated instead of the top 10 in the similarity of the topic vector, it is possible to easily obtain the number of desired speakers. For example, the number is increased to the top 20 or the like.

On the other hand, in a case where the variance is sufficiently large, the number of pieces of the TTS reference data RD to be evaluated does not have to be so large.

A mathematical expression of this state is (Math. 4), and the variance is taken as the denominator. The symbol y is the number of pieces of the TTS reference data RD to be evaluated.

$$y = \frac{30}{( {σ}^{2} + 1 )} \qquad [ Math . 4 ]$$

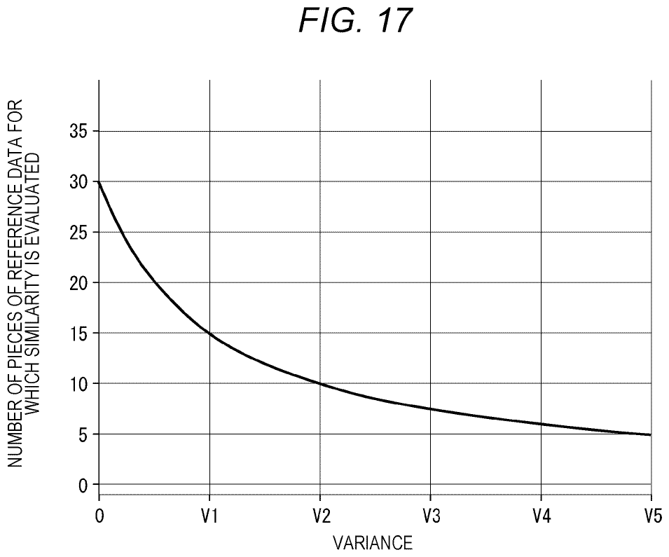

FIG. 17 is a graph of (Math. 4). It can be seen that the number of pieces of reference data to be evaluated changes according to a value (V) of the variance. When the variance is close to zero, 30 pieces of the TTS reference data RD are used to examine a variation of the voice quality. On the other hand, in a case where the variance is large, a wide variation of voice qualities can be obtained from less than or equal to 10 pieces of the TTS reference data RD.

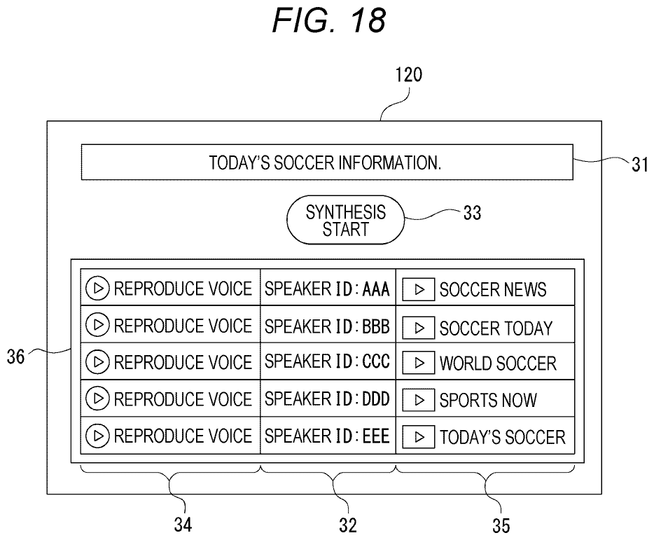

In the above manner, a plurality of speakers can be suggested to the user 10 with variations of the voice quality of the speaker while the topics are similar to each other, and in that case, for example, it is conceivable to perform display as illustrated in FIG. 18 by the display 120 of the information terminal 100.

As the topic, “soccer” is illustrated as an example. Similarly to FIG. 13, the text box 31, the speaker ID 32, the synthesis start button 33, the reproduction button 34, and the reference URL 35 are displayed on the display 120. However, the reproduction button 34, the speaker ID 32, and the reference URL 35 are illustrated as a synthesized voice list 36. That is, a list of a plurality of speakers as candidates for use in the content CT1 is displayed.

In the synthesized voice list 36, speakers are displayed from the top in descending order of the cosine similarity of the topic vector. In addition, as described above, each of these speakers is a speaker with a different voice quality, including an optimal speaker, an orthogonal speaker, and a reverse speaker.

For each speaker, the topic is “soccer” that matches the topic of text information input in the text box 31, and when the speaker ID is selected, a link to the reference content CT2 in which speakers of various voice qualities appear is displayed as the reference URL 35.

For example, in the example of FIG. 18, five speakers are presented, and the user 10 can reproduce the voice of each speaker with the reproduction button 34. Furthermore, the user 10 can confirm the voice of the reference content CT2 referred to for selecting the speaker ID by operating the reference URL 35.

Here, an advantage of suggesting a plurality of speaker candidates for one piece of content CT1 will be considered.

For example, it is assumed that the present technology is applied to video content such as an online class for elementary school students.

In a case where there are subjects such as Japanese, mathematics, science, and social studies, the text data TD of these four subjects is not collectively subjected to topic analysis, but the topic analysis is performed for each subject, so that it is possible to obtain a voice like a teacher of each subject.

When consideration is performed only by the topic vector of the text data TD, for example, voices of teachers in Japanese and social studies may be similar to each other. In order to avoid being monotonous, the user 10 may want to vary the speaker of each subject.

In such a case, by performing a topic search with the topic vector TV of Japanese and social studies to select an orthogonal speaker and a reverse speaker from reference data having a higher cosine similarity, it is possible to avoid overlapping of similar voices.

Furthermore, it is also conceivable to automatically divide a long sentence into a plurality of topics and change the speaker.

For example, even in video content in Japanese, there are various topics such as “novel”, “review”, and “poetry” as a teaching unit. For example, “poetry” and the like should be read emotionally.

In such a case, it is possible to suggest a speaker in a certain group by performing topic analysis in units of paragraphs of sentences. As a method of detecting a paragraph of sentences, detection can be performed by detecting an indentation or a blank line.

### 9. Configuration of Information Processing Apparatus

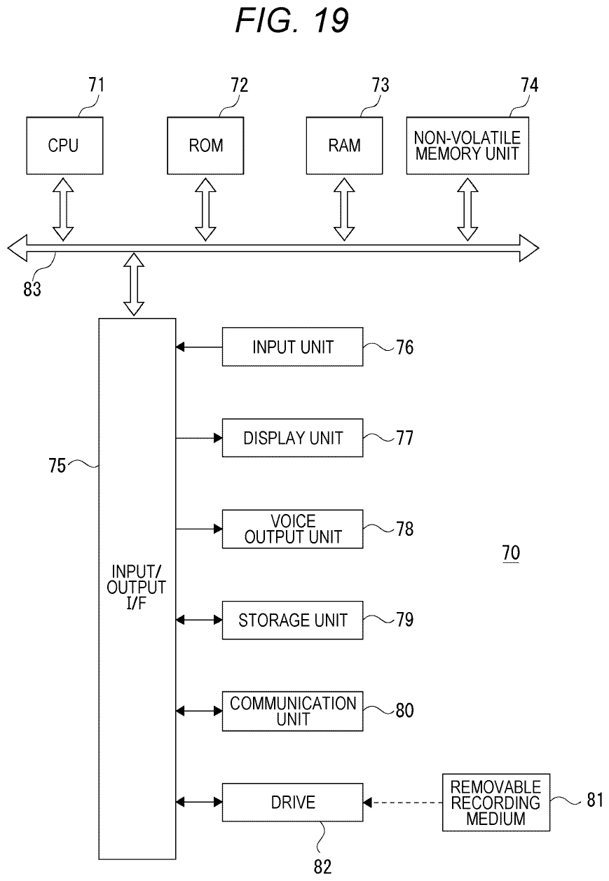

With reference to FIG. 19, a description will be given of a configuration example of an information processing apparatus 70 that can be used as the voice synthesis server 200, the content analysis server 300, the database 400, and the information terminal 100 in the TTS speaker suggestion system 1.

The information processing apparatus 70 can be configured as, for example, a dedicated workstation, a general-purpose personal computer, a mobile terminal device, or the like.

A CPU 71 of the information processing apparatus 70 illustrated in FIG. 19 executes various types of processing in accordance with a program stored in a ROM 72 or a non-volatile memory unit 74, for example, an electrically erasable programmable read-only memory (EEP-ROM) or the like, or a program loaded from a storage unit 79 to a RAM 73. The RAM 73 also stores, as appropriate, data and the like necessary for the CPU 71 to execute the various types of processing.

The CPU71 implements, by a program, functions of performing various types of control and calculation in FIGS. 2, 3, 4, and 5.

Note that a graphics processing unit (GPU), a general-purpose computing on graphics processing units (GPGPU), an artificial intelligence (AI) processor, or the like may be provided as a processor different from the CPU 71.

The CPU 71, the ROM 72, the RAM 73, and the non-volatile memory unit 74 are connected to one another via a bus 83. Furthermore, an input/output interface 75 is also connected to the bus 83.

An input unit 76 including an operation element or an operation device is connected to the input/output interface 75. For example, as the input unit 76, various operation elements and operation devices are assumed such as a keyboard, a mouse, a key, a dial, a touch panel, a touch pad, or a remote controller.

Operation by the user 10 is detected by the input unit 76, and a signal according to the operation input is interpreted by the CPU 71.

Furthermore, a display unit 77 including a liquid crystal display (LCD), an organic electro-luminescence (EL) panel, or the like, and a voice output unit 78 including a speaker or the like are integrally or separately connected to the input/output interface 75.

The display unit 77 performs various types of display as a user interface. The display unit 77 includes, for example, a display device provided on a housing of the information processing apparatus 70, a separate display device connected to the information processing apparatus 70, or the like.

The display unit 77 displays various images on a display screen on the basis of an instruction from the CPU 71. Furthermore, the display unit 77 performs display of various operation menus, icons, messages and the like, that is, performs display as a graphical user interface (GUI) on the basis of an instruction from the CPU 71.

In some cases, the storage unit 79 including a solid state drive (SSD), a hard disk drive (HDD), and the like, and a communication unit 80 including a modem and the like are connected to the input/output interface 75.

The storage unit 79 can be used for storage of various types of data. A database can be constructed in the storage unit 79.

For example, it is possible to configure the held speaker data unit 240 of the voice synthesis server 200, the storage unit 340 of the content analysis server 300, the storage unit 410 of the database 400, and the like by using the storage unit 79.

The communication unit 80 performs communication processing via the network 600.

For example, it is possible to configure the network communication unit 150 of the information terminal 100, the network communication unit 260 of the voice synthesis server 200, the network communication unit 370 of the content analysis server 300, and the network communication unit 440 of the database 400 by using the communication unit 80.

Furthermore, a drive 82 is connected to the input/output interface 75, as necessary, and a removable recording medium 81 such as a flash memory, a memory card, a magnetic disk, an optical disk, or a magneto-optical disk is appropriately mounted.

The drive 82 can read a data file such as an image file, various computer programs and the like from the removable recording medium 81. The read data file is stored in the storage unit 79, and images and voices included in the data file are output by the display unit 77 and the voice output unit 78. Furthermore, the computer programs and the like read from the removable recording medium 81 are installed in the storage unit 79, as necessary.

In the information processing apparatus 70, software can be installed through network communication by the communication unit 80, or the removable recording medium 81. Alternatively, the software may be stored in advance in the ROM 72, the storage unit 79, or the like.

With such an information processing apparatus 70, it is possible to configure the information terminal 100, the voice synthesis server 200, the content analysis server 300, and the database 400. Then, it is possible to implement the configuration of FIG. 2 as the information terminal 100, the configuration of FIG. 3 as the voice synthesis server 200, the configuration of FIG. 4 as the content analysis server 300, and the configuration of FIG. 5 as the database 400 by the hardware configuration of the information processing apparatus 70 of FIG. 19 and the software installed therein.

### 10. Summary and Modifications

In the above embodiment, the following effects can be obtained.

The voice synthesis server 200 according to the embodiment includes: the speaker search unit 230 that performs a search based on a topic of the text data TD among a plurality of pieces of speaker data to selects speaker data; and the voice synthesis unit 250 that generates a synthesized voice of the text data TD with the speaker data selected by the speaker search unit 230 (see FIG. 3).

That is, speaker data with a voice quality according to a topic (subject or genre thereof) as detail of the text data TD is selected, and a read voice of the text data TD is synthesized, with the speaker data. As a result, instead of unnecessarily providing the synthesized voice data AD of various voice qualities for the text data TD, it is possible to provide, to the user 10, the synthesized voice data AD by the speaker data with a voice quality matching the topic of the text data TD of the content CT1.

An example has been described in which, in the voice synthesis server 200 according to the embodiment, the speaker search unit 230 acquires the TTS reference data RD selected on the basis of the topic of the text data TD, and selects the speaker data among the plurality of pieces of speaker data on the basis of the similarity between the voice feature indicated by the TTS reference data RD and the voice feature of the speaker data (see FIG. 11).

By acquiring the TTS reference data RD, it is possible to obtain information of the voice feature amount RDX that is generally considered to be suitable for the topic of the text data TD. Thus, the voice synthesis server 200 can select speaker data appropriate for the topic of the text data TD to be processed among pieces of speaker data held in the held speaker data unit 240.

It has been described that, in the voice synthesis server 200 according to the embodiment, the reference data acquisition unit 220 externally transmits the text data TD to the database 400, and receives the TTS reference data RD from the database 400 (see FIGS. 6 and 11).

By acquiring the TTS reference data RD from the database 400, the voice synthesis server 200 does not need to store a large number of pieces of the TTS reference data RD. Then, the voice synthesis server 200 can select appropriate speaker data among pieces of held speaker data on the basis of the voice feature amount RDX of the TTS reference data RD according to the text data TD to be processed. That is, it is possible to select appropriate speaker data among pieces of speaker data stored in the voice synthesis server 200 without performing processing such as storage, addition, and management of the TTS reference data RD.

In the embodiment, it has been described that the TTS reference data RD includes the topic vector RDT serving as the index of the classification of topics of the reference content CT2 (the index of the similarity/dissimilarity determination) (see FIG. 5).

As a result, the database 400 can compare the topic vector RDT of the TTS reference data RD with the topic vector TV of the text data TD to be processed received from the voice synthesis server 200, and select the TTS reference data RD according to the topic of the text data TD. Thus, the TTS reference data RD suitable for the topic of the text data TD to be processed can be selected.

Furthermore, it has been described that the TTS reference data RD includes a voice feature amount obtained by feature amount extraction of voice data of the reference content CT2 (see FIG. 5).

The voice feature amount RDX is included in the TTS reference data RD, whereby the voice synthesis server 200 can select speaker data with a voice quality similar to the voice feature amount RDX, and this is speaker data with a voice quality matching the topic of the text data TD.

Furthermore, it has been described that the TTS reference data RD includes information indicating the reference content CT2 used for creation of the TTS reference data RD (see FIG. 5). For example, the URL (RDU) of the content is included as the information indicating the reference content CT2.

As a result, as illustrated in FIGS. 13 and 18, a user interface is possible that enables the user 10 to view the reference content CT2. By knowing what reference content CT2 the synthesized voice by the voice synthesis server 200 is selected on the basis of, the user 10 can use that as a reference for content production.

The voice synthesis server 200 according to the embodiment includes the network communication unit 260 that performs processing of transmitting, to the information terminal 100 that is a transmission source of the text data, information on speaker data selected by the speaker search unit 230, and synthesized voice generated by the voice synthesis unit 250 (see FIG. 3).

As described with reference to FIG. 11, the voice synthesis server 200 transmits the speaker ID and the synthesized voice data AD to the information terminal 100 by the network communication unit 260. As a result, it is possible to perform a service of suggesting the synthesized voice suitable for the content CT1 to the user 10 on the display screen as illustrated in FIGS. 13 and 18.

It has been described that, in the voice synthesis server 200 according to the embodiment, the network communication unit 260 performs processing of transmitting information regarding the reference content CT2 included in the TTS reference data RD to the information terminal 100 that is a transmission source of the text data TD (see FIG. 11).

As a result, it is possible to provide a guiding line for displaying the reference URL 35 on the display screen as illustrated in FIGS. 13 and 18 and allowing the user 10 to view the reference content CT2.

In the embodiment, an example has been described in which, for each of a plurality of pieces of the TTS reference data RD selected on the basis of the topic of the text data TD, the speaker search unit 230 of the voice synthesis server 200 selects the speaker data on the basis of the similarity between the voice feature indicated by the TTS reference data RD and the voice feature of the speaker data to be stored.

The voice synthesis server 200 can obtain a plurality of pieces of information of the voice feature amount RDX suitable for the topic of the text data TD by acquiring a plurality of pieces of the TTS reference data RD (for example, TTS reference data RD #1, RD #x, and RD #y in FIG. 16). Thus, the voice synthesis server 200 can select a plurality of pieces of speaker data suitable for a topic of the content CT1 by selecting pieces of the speaker data on the basis of respective pieces of the TTS reference data RD #1,RD #x, and RD #y among pieces of the speaker data held in the held speaker data unit 240, and can suggest the respective voice qualities to the user 10.

In the embodiment, an example has been described in which the network communication unit 260 transmits information of the speaker data selected on the basis of the plurality of pieces of the TTS reference data RD as information displayed in a list on the information terminal 100.

For example, the speaker ID 32 and the like are displayed as a list as the synthesized voice list 36 in FIG. 18. As a result, the user 10 can listen to voices of a plurality of candidate voice qualities on a trial basis under a condition that the voice quality is suitable for the topic of the content CT1.

It has been described that such a plurality of pieces of the TTS reference data RD is reference data further selected from a plurality of pieces of the TTS reference data RD selected in descending order of the similarity with the topic of the text data TD. Then, an example has been described in which the reference data includes first reference data evaluated that a topic of the original reference content CT2 has the highest similarity with the topic of the text data TD, and one or a plurality of pieces of second reference data selected on the basis of similarity evaluation with the first reference data. For example, as illustrated in FIG. 16, a plurality of pieces of the TTS reference data RD (RD #1 to RD #10) is selected. The first reference data (TTS reference data RD #1) evaluated as having the highest similarity among them, and one or a plurality of pieces of the second reference data (TTS reference data RD #x, RD #y) are selected. As a result, it is possible to select the TTS reference data RD of various voice qualities and matching the topic by a method of similarity evaluation.

Furthermore, it has been described that the second reference data in this case is reference data evaluated, in the similarity evaluation, that the cosine similarity is in an orthogonal or opposite direction with a voice feature amount of the first reference data as a reference.

As a result, the plurality of pieces of the TTS reference data RD #1, RD #x, and RD #y has voice feature amounts RDX of voice qualities that are not similar to each other. Thus, the voice synthesis server 200 can provide pieces of the speaker data to the user 10 as variations with different voice qualities on the basis of these.

Furthermore, it has been described that the number of the plurality of pieces of reference data selected in descending order of the similarity with the topic of the text data TD is set according to the variance of the voice feature amount (see FIGS. 16, 17, and the like).

As a result, in a case where the plurality of pieces of the TTS reference data RD selected first in descending order of the similarity has a generally similar voice qualities, it is possible to increase the number to increase the variance so that pieces of the TTS reference data RD #x and RD #y selected on the basis of the similarity evaluation do not have voice qualities similar to a voice quality of the TTS reference data RD #1. That is, a population of selection of the TTS reference data RD is controlled according to the variance, whereby it is possible to maintain a state in which variations of the voice quality finally suggested to the user 10 is widened.

The TTS speaker suggestion system 1 according to the embodiment includes a content analysis device (content analysis server 300) that analyzes the reference content CT2 and generates the TTS reference data RD including information regarding a topic and information regarding a voice feature. Furthermore, the TTS speaker suggestion system 1 includes the database 400 that stores the TTS reference data RD generated by the content analysis server 300 and selects the TTS reference data RD on the basis of the topic of the text data TD. Moreover, as described above, the system includes the voice synthesis server 200 including the speaker search unit 230 and the voice synthesis unit 250.

In the TTS speaker suggestion system 1, the content analysis server 300 and the database 400 generate and accumulate the TTS reference data RD on the basis of the various types of the reference content CT2. The voice synthesis server 200 can provide a synthesized voice matching the text data TD received from the information terminal 100 by using such information resources. As the quality and amount of the TTS reference data RD become more sufficient, the voice synthesis server 200 can provide the user 10 with a synthesized voice having a voice quality more matching the text data TD.

The program according to the embodiment is a program for causing, for example, a CPU, a digital signal processor (DSP), an AI processor, or the like, or the information processing apparatus 70 including the CPU, the DSP, the AI processor, or the like, to execute the processing as illustrated in FIG. 11.

That is, the program according to the embodiment is a program for causing an information processing apparatus to execute: speaker search processing of performing a search based on a topic of the text data TD among a plurality of pieces of speaker data to select speaker data; and voice synthesis processing of generating a synthesized voice of the text data TD with the speaker data selected in the speaker search processing.

With such a program, the information processing apparatus as the voice synthesis server 200 according to the embodiment can be implemented in, for example, a computer device, a mobile terminal device, or another device capable of performing information processing.

Such a program can be recorded in advance in an HDD as a recording medium built in equipment such as a computer device or the like, a ROM in a microcomputer including a CPU, and the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called package software.

Furthermore, such a program can be installed from the removable recording medium into a personal computer or the like, or can be downloaded from a download site through a network such as a local area network (LAN) or the Internet.

Furthermore, with such a program, the information processing apparatus 70 constituting the voice synthesis server 200 according to the embodiment is suitably provided in a wide range. By downloading of the program to a mobile terminal device such as a smartphone or a tablet, an imaging device, a mobile phone, a personal computer, a gaming device, a video device, a personal digital assistant (PDA), or the like, for example, these devices can be made as the information processing apparatus 70 that functions as the voice synthesis server 200 of the present disclosure.

Note that the effects described in the present specification are merely examples and are not restrictive, and other effects may also be produced.

Note that the present technology can also adopt the following configurations.

(1)

An information processing apparatus including:
a speaker search unit that performs a search based on a topic of text data among a plurality of pieces of speaker data to select speaker data; and
a voice synthesis unit that generates synthesized voice data of the text data with the speaker data selected by the speaker search unit.
   (2)

The information processing apparatus according to (1), in which
the speaker search unit acquires reference data selected on the basis of the topic of the text data, and selects the speaker data among the plurality of pieces of speaker data on the basis of a similarity between a voice feature indicated by the reference data and a voice feature of the speaker data.
   (3)

The information processing apparatus according to (2), in which
the text data is externally transmitted to a database, and the reference data is received from the database.
   (4)

The information processing apparatus according to (2) or (3), in which
the reference data includes
a topic vector serving as an index of classification of topics of reference content used for reference data creation.
   (5)

The information processing apparatus according to any of (2) to (4), in which
the reference data includes
a voice feature amount obtained by feature amount extraction of voice data of reference content used for reference data creation.
   (6)

The information processing apparatus according to any of (2) to (5), in which
the reference data includes
information indicating reference content used for reference data creation.
   (7)

The information processing apparatus according to any of (1) to (6), further including
a communication unit that performs processing of transmitting, to an information terminal that is a transmission source of the text data, information of the speaker data selected by the speaker search unit, and the synthesized voice data generated by the voice synthesis unit.
   (8)

The information processing apparatus according to (7), in which
the speaker search unit acquires reference data selected on the basis of the topic of the text data, and selects the speaker data among the plurality of speaker data on the basis of a similarity between a voice feature indicated by the reference data and a voice feature of the speaker data, and
the communication unit performs processing of transmitting, to an information terminal that is a transmission source of the text, information regarding reference content used for creation of the reference data, the information being included in the reference data.
   (9)

The information processing apparatus according to any of (1) to (8), in which
the speaker search unit selects, for each of a plurality of pieces of reference data selected on the basis of the topic of the text data, the speaker data on the basis of a similarity between a voice feature indicated by the reference data and a voice feature of the speaker data.
   (10)

The information processing apparatus according to (9), further including a communication unit that performs processing of transmitting, to an information terminal that is a transmission source of the text data, information of the speaker data selected by the speaker search unit, and the synthesized voice generated by the voice synthesis unit, in which
the information of the speaker data selected on the basis of a plurality of pieces of the reference data is transmitted as information displayed in a list on the information terminal.
   (11)

The information processing apparatus according to (9) or (10), in which
the plurality of pieces of reference data
is reference data further selected from a plurality of pieces of reference data selected in descending order of the similarity with the topic of the text data, and includes
first reference data evaluated that a topic of original reference content has the highest similarity with the topic of the text data, and
one or a plurality of pieces of second reference data selected on the basis of similarity evaluation with the first reference data.
   (12)

The information processing apparatus according to (11), in which
the second reference data is reference data for which it is evaluated, in the similarity evaluation, that a cosine similarity is in an orthogonal or opposite direction with a voice feature amount of the first reference data as a reference.
   (13)

The information processing apparatus according to (11) or (12), in which
the number of the plurality of pieces of reference data selected in descending order of the similarity with the topic of the text data is set according to variance of voice feature amounts.
   (14)

An information processing method executed by an information processing apparatus, the information processing method including:
speaker search processing of performing a search based on a topic of text data among a plurality of pieces of speaker data to select speaker data; and
voice synthesis processing of generating synthesized voice of the text data with the speaker data selected by the speaker search processing.

(15) A program for causing an information processing apparatus to execute:
speaker search processing of performing a search based on a topic of text data among a plurality of pieces of speaker data to select speaker data; and
voice synthesis processing of generating synthesized voice of the text data with the speaker data selected by the speaker search processing.
   (16)

An information processing system including:
a content analysis device that analyzes reference content to generate reference data including information regarding a topic and information regarding a voice feature;
a database that stores the reference data generated by the content analysis device and selects reference data on the basis of a topic of text data; and
a voice synthesis device, in which
the voice synthesis device includes:
a speaker search unit that acquires the reference data selected by the database on the basis of the topic of the text data, and selects speaker data among a plurality of pieces of speaker data on the basis of a similarity between a voice feature indicated by the reference data and a voice feature of the speaker data; and
a voice synthesis unit that generates synthesized voice data of the text data with the speaker data selected by the speaker search unit.

REFERENCE SIGNS LIST

| | |
|---|---|
| 1 | TTS speaker suggestion system |
| 70 | Information processing apparatus |
| 71 | CPU |
| 100 | Information terminal |
| 200 | Voice synthesis server |
| 210 | Text-phoneme symbol conversion unit |
| 220 | Reference data acquisition unit |
| 230 | Speaker search unit |
| 240 | Held speaker data unit |
| 250 | Voice synthesis unit |
| 260 | Network communication unit |
| 300 | Content analysis server |
| 400 | Database |
| 500 | Content provider |
| RDT | Topic vector |
| RDX | Voice feature amount |
| RDU | URL of content |
| TD | Text data |
| AD | Synthesized voice data |
| RD | TTS reference data |
| TM | Topic model |
| TV | Topic vector |
| XV | Voice feature amount |
| CT1 | Content (created by user) |
| CT2 | Reference content (for analysis) |

1. An information processing apparatus comprising:
a speaker search unit that performs a search based on a topic of text data among a plurality of pieces of speaker data to select speaker data; and
a voice synthesis unit that generates synthesized voice data of the text data with the speaker data selected by the speaker search unit.

2. The information processing apparatus according to claim 1, wherein
the speaker search unit acquires reference data selected on a basis of the topic of the text data, and selects the speaker data among the plurality of pieces of speaker data on a basis of a similarity between a voice feature indicated by the reference data and a voice feature of the speaker data.

3. The information processing apparatus according to claim 2, wherein
the text data is externally transmitted to a database, and the reference data is received from the database.

4. The information processing apparatus according to claim 2, wherein
the reference data includes
a topic vector serving as an index of classification of topics of reference content used for reference data creation.

5. The information processing apparatus according to claim 2, wherein
the reference data includes
a voice feature amount obtained by feature amount extraction of voice data of reference content used for reference data creation.

6. The information processing apparatus according to claim 2, wherein
the reference data includes
information indicating reference content used for reference data creation.

7. The information processing apparatus according to claim 1, further comprising
a communication unit that performs processing of transmitting, to an information terminal that is a transmission source of the text data, information of the speaker data selected by the speaker search unit, and the synthesized voice data generated by the voice synthesis unit.

8. The information processing apparatus according to claim 7, wherein
the speaker search unit acquires reference data selected on a basis of the topic of the text data, and selects the speaker data among the plurality of speaker data on a basis of a similarity between a voice feature indicated by the reference data and a voice feature of the speaker data, and
the communication unit performs processing of transmitting, to an information terminal that is a transmission source of the text, information regarding reference content used for creation of the reference data, the information being included in the reference data.

9. The information processing apparatus according to claim 1, wherein
the speaker search unit selects, for each of a plurality of pieces of reference data selected on a basis of the topic of the text data, the speaker data on a basis of a similarity between a voice feature indicated by the reference data and a voice feature of the speaker data.

10. The information processing apparatus according to claim 9, further comprising a communication unit that performs processing of transmitting, to an information terminal that is a transmission source of the text data, information of the speaker data selected by the speaker search unit, and the synthesized voice generated by the voice synthesis unit, wherein
the information of the speaker data selected on a basis of a plurality of pieces of the reference data is transmitted as information displayed in a list on the information terminal.

11. The information processing apparatus according to claim 9, wherein
the plurality of pieces of reference data
is reference data further selected from a plurality of pieces of reference data selected in descending order of the similarity with the topic of the text data, and includes
first reference data evaluated that a topic of original reference content has a highest similarity with the topic of the text data, and
one or a plurality of pieces of second reference data selected on a basis of similarity evaluation with the first reference data.

12. The information processing apparatus according to claim 11, wherein
the second reference data is reference data for which it is evaluated, in the similarity evaluation, that a cosine similarity is in an orthogonal or opposite direction with a voice feature amount of the first reference data as a reference.

13. The information processing apparatus according to claim 11, wherein
a number of the plurality of pieces of reference data selected in descending order of the similarity with the topic of the text data is set according to variance of voice feature amounts.

14. An information processing method executed by an information processing apparatus, the information processing method comprising:
speaker search processing of performing a search based on a topic of text data among a plurality of pieces of speaker data to select speaker data; and
voice synthesis processing of generating synthesized voice of the text data with the speaker data selected by the speaker search processing.

15. A program for causing an information processing apparatus to execute:
speaker search processing of performing a search based on a topic of text data among a plurality of pieces of speaker data to select speaker data; and
voice synthesis processing of generating synthesized voice of the text data with the speaker data selected by the speaker search processing.

16. An information processing system comprising:
a content analysis device that analyzes reference content to generate reference data including information regarding a topic and information regarding a voice feature;
a database that stores the reference data generated by the content analysis device and selects reference data on a basis of a topic of text data; and
a voice synthesis device, wherein
the voice synthesis device includes:
a speaker search unit that acquires the reference data selected by the database on the basis of the topic of the text data, and selects speaker data among a plurality of pieces of speaker data on a basis of a similarity between a voice feature indicated by the reference data and a voice feature of the speaker data; and
a voice synthesis unit that generates synthesized voice data of the text data with the speaker data selected by the speaker search unit.
